(19) United States
(12) Patent Application Publication
(10) Pub. No.: US 2002/0040750 A1
(43) Pub. Date: Apr. 11, 2002

(54) Vehicle tire with breaker and anti-knock arrangement

(76) Inventor: Shut Chen Hsu, I Lan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/789,619

(22) Filed: Feb. 22, 2001

(30) Foreign Application Priority Data
Oct. 7, 2000 (TW) 089120993

(51) Int. Cl. B60C 9/00

(52) U.S. Cl. 152/532; 152/536

(57) ABSTRACT

A vehicle tire includes an outer tire, the outer tire having an intermediate layer of breaker of woven fabrics, a bottom layer of breaker of woven fabrics, and two inward lips respectively extended along two ends thereof, and an annular tire support structure mounted in the outer tire and connected between the lips of the outer tire, the annular tire support structure being formed of a plurality of reinforcing bearing devices connected in series and fastened to the lips of the outer tire, the reinforcing bearing devices each formed of a smoothly arched left bearing member and a smoothly arched right bearing member hooked up with the left bearing member.

### BACKGROUND OF THE INVENTION

The present invention relates to vehicle tires and, more particularly, to such a vehicle tire, which has means to protect the tire against piercing of external sharp objects.

For a safety driving, the condition of vehicle tires must be regularly checked. There are two kinds of vehicle tires used in existing motorcars, namely, the tire having an inner tube, and the tire without inner tube. According to conventional tire designs, a meshed metal wire structure formed of transverse metal wires 10 and a longitudinal metal wires 10b is arranged in between the carcass and the tread. The two layers of metal wires 10 and 10b are arranged at 17˜26°. This meshed metal wire structure can only reinforce the structural strength of the tire. It cannot protect the tire against piercing of an external sharp object. When a nail or the like pierced through the open spaces in the meshed metal wire structure, the tire leaks, and a tire explosion accident may occur.

### SUMMARY OF THE INVENTION

The present invention has been accomplished to provide a vehicle tire, which eliminates the aforesaid problems. According to one aspect of the present invention, the vehicle tire comprises an outer tire, and an annular tire support structure mounted in the outer tire and connected between the lips of the outer tire. According to another aspect of the present invention, the outer tire comprises an intermediate layer of breaker of woven fabrics, a bottom layer of breaker of woven fabrics, and two inward lips respectively extended along two ends thereof. According to still another aspect of the present invention, the annular tire support structure is comprised of a plurality of reinforcing bearing devices connected in series and fastened to the lips of the outer tire, the reinforcing bearing devices each formed of a smoothly arched left bearing member and a smoothly arched right bearing member hooked up with the left bearing member.

### BRIEF DESCRIPTION OF THE DRAWINGS

FIG. 1 illustrates a nail pierced through the open spaces in the meshed metal wire structure of a vehicle tire according to the prior art.

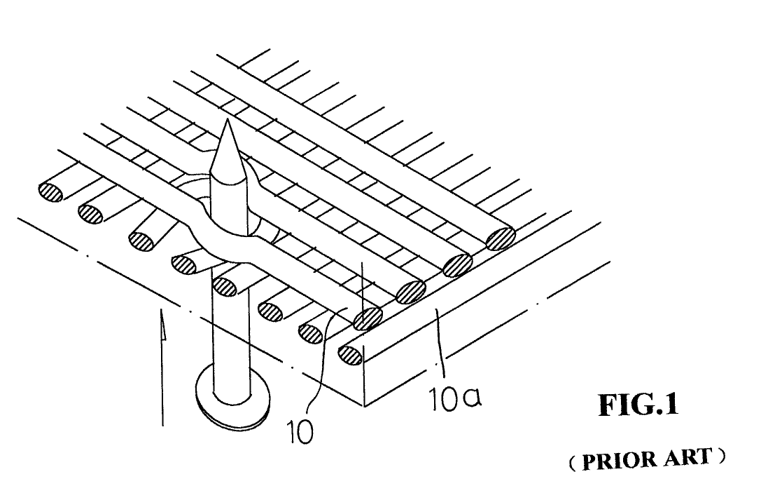

FIG. 2 is a sectional elevation of a vehicle tire according to the present invention.

FIG. 3 illustrates one woven example of the breakers according to the present invention.

FIG. 4 illustrates another woven example of the breakers according to the present invention.

FIG. 5 is a perspective view of one reinforcing bearing device according to the present invention.

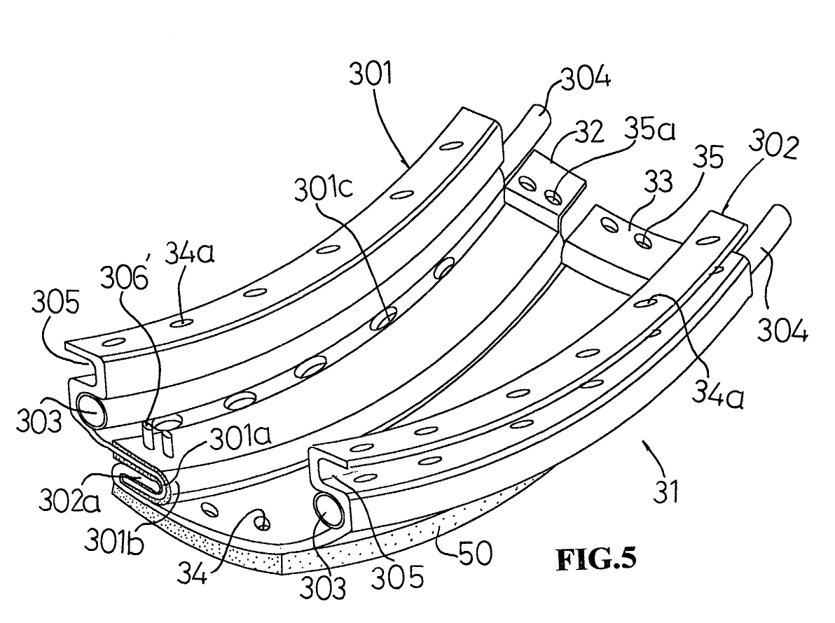

FIG. 6 is an exploded view of a part of the annular tire support structure according to the present invention.

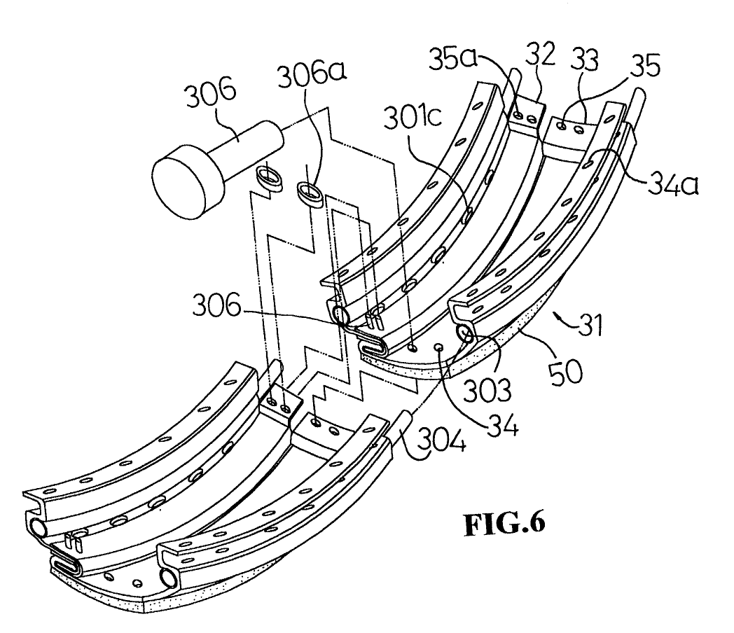

FIG. 7 is a sectional view of a vehicle tire according to the present invention.

FIG. 8 is another sectional view of the vehicle tire according to the present invention.

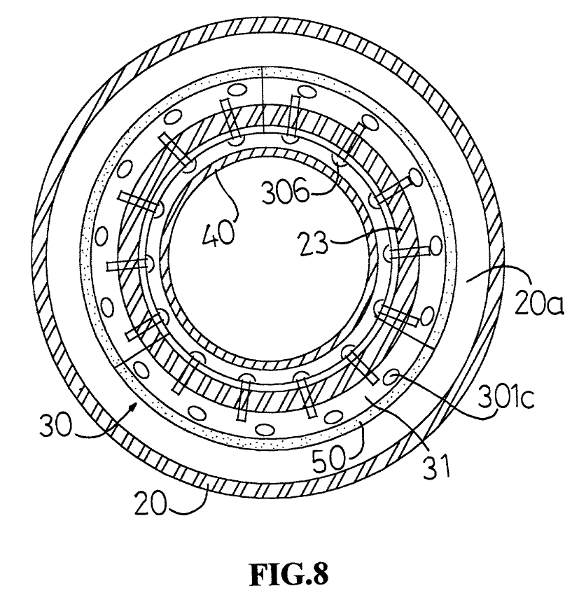

### DETAILED DESCRIPTION OF THE PREFERRED EMBODIMENT

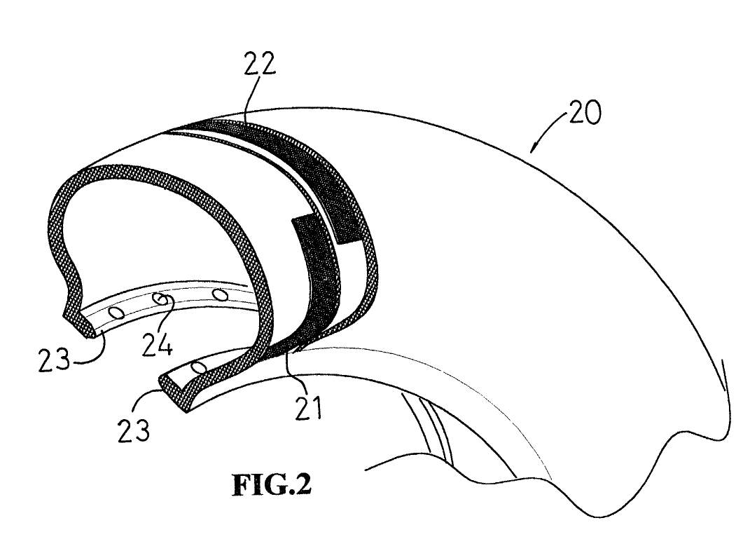

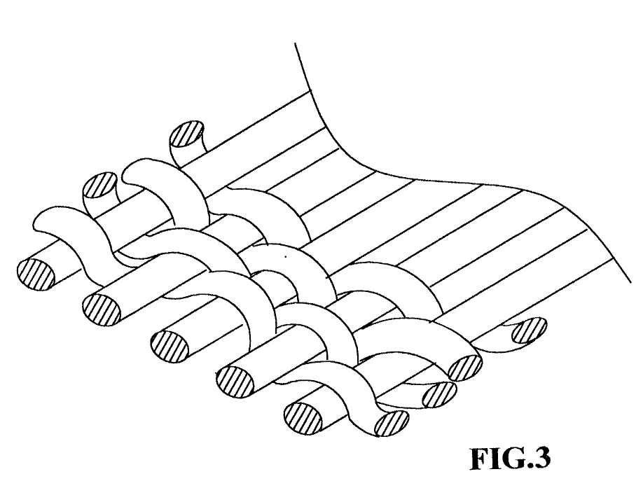

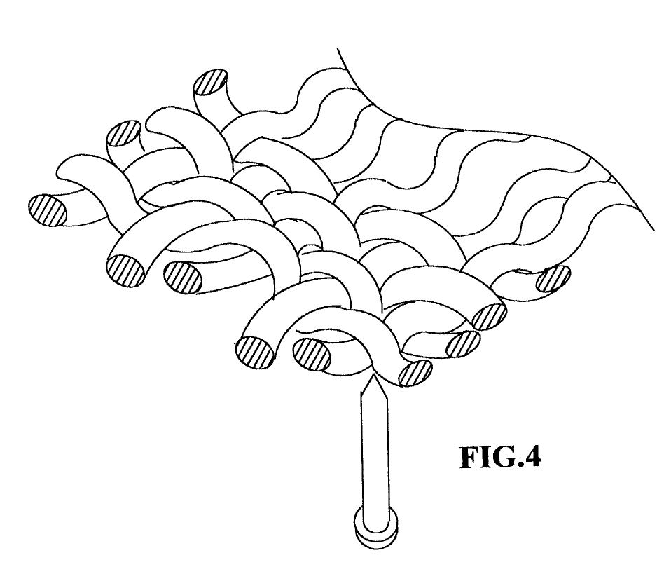

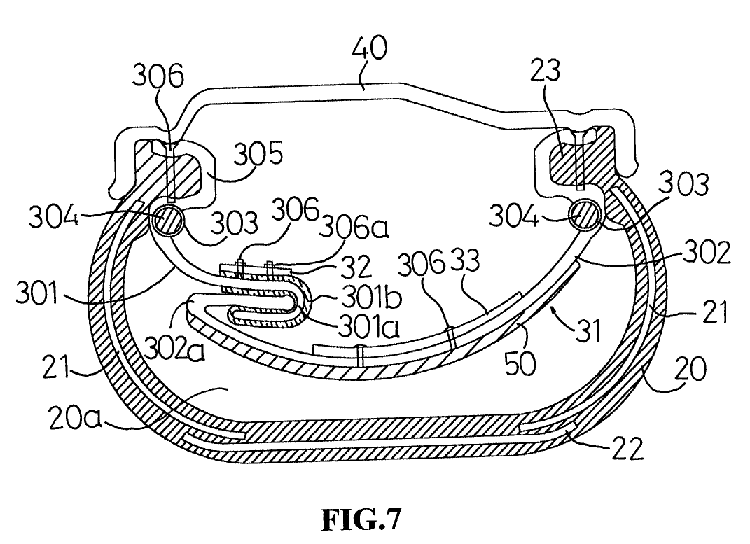

Referring to FIGS. from 1 through 8, the outer tire 20 (see FIG. 2) comprises an intermediate layer of breaker 21 (See FIG. 7), a bottom layer of breaker 22, two inward lips 23 respectively extended along two ends thereof, and two rows of mounting holes 24 respectively arranged on the inward lips 23. The breakers 21 and 22 are woven fabrics of flexible strings. In the embodiment shown in FIG. 3, the longitudinal flexible strings are arranged in straight, and the transverse flexible strings are alternatively extended over top and bottom sides of the longitudinal flexible strings in a wave-like manner. In the embodiment shown in FIG. 4, the transverse flexible strings and the longitudinal flexible strings are arranged in a wave-like manner. The breakers 21 and 22 can be formed of multiple layers of woven fabrics (FIGS. 3 and 4 show only one layer of woven fabrics).

A plurality of reinforcing bearing devices 31 are connected in series and fastened to the outer tire 20 between the lips 23 (see FIGS. from 5 through 7). Each reinforcing bearing device 31 is comprised of a smoothly arched left bearing member 301 and a smoothly arched right bearing member 302. The bearing members 301 and 302 have a respective hooked portion 301a or 302a longitudinally disposed at an inner side and hooked up with each other. The left bearing member 301 has a friction covering 301b covered over the hooked portion 301a and pressed against the hooked portion 302a of the right bearing member 302. The reinforcing bearing devices 31 each comprise a rail 305 longitudinally disposed at an outer side, a plurality of mounting holes 34a, a longitudinal row of air holes 301c disposed between the hooked portion 301a/302a and the rail 305, and a plug rod 304 disposed at one end, namely, the rear end, a plug hole 303 disposed at an opposite end, namely, the front end. The left bearing member 301 further comprises a plurality of bolts 306′ disposed near the front end, a mounting flange 32 with mounting holes 35a disposed at the rear end. The right bearing member 302 further comprises a mounting flange 33 with mounting holes 35 disposed at the rear end, a plurality of mounting holes 34 disposed near the front end, and a pad 50 fastened to the bottom sidewall thereof.

Referring to FIGS. from 6 through 8, during installation, the plug rods 304 of one reinforcing bearing device 31 are plugged into the plug holes 303 of another reinforcing bearing device 31; the bolts 306′; the bolts 306′ of one reinforcing bearing device 31 are fastened to the mounting holes 35a of the mounting flange 32 of another reinforcing bearing device 31; the mounting holes 35 of the mounting flange 33 of one reinforcing bearing device 31 are fastened to the mounting holes 34 of another reinforcing bearing device 31 by screw bolts 306 and nuts 306a. After the reinforcing bearing devices 31 had been fastened to one another, the connected reinforcing bearing devices 31 form an annular tire support structure 30. The annular tire support structure 30 is inserted into the air chamber 20a of the outer tire 20, and then the mounting holes 34a of the rails 305 of the reinforcing bearing devices 31 of the annular tire support structure 30 are respectively fastened to the respective mounting holes 24 of the lips 23 of the outer tire 20 by screw bolts 306, and at final the rim 40 is installed.

In case a pointed external object pierced the outer tire 30, the breakers 21 and 22 block the pointed external object from passing to the inside, and the annular tire support structure 30 supports the vehicle tire, enabling the vehicle tire to keep running.

It is to be understood that the drawings are designed for purposes of illustration only, and are not intended for use as a definition of the limits and scope of the invention disclosed.

What the invention claimed is:

1. A vehicle tire comprising:
an outer tire, said outer tire comprising an intermediate layer of breaker of woven fabrics, a bottom layer of breaker of woven fabrics, two inward lips respectively extended along two ends thereof, and two rows of mounting holes respectively arranged on the inward lips, said breakers each comprised of multiple layers of woven fabrics formed of flexible strings longitudinally transversely across one another;
an annular tire support structure mounted in said outer tire and connected between the lips of said outer tire, said annular tire support structure comprised of a plurality of reinforcing bearing devices connected in series and fastened to the lips of said outer tire, said reinforcing bearing devices each comprised of a smoothly arched left bearing member and a smoothly arched right bearing member, said left bearing members comprising a rail longitudinally disposed at one end and fastened to one lip of said outer tire by screw bolts, a longitudinal series of air holes, a front plug hole, a rear plug rod corresponding to said front plug hole for mounting, a rear mounting flange, said front mounting flange having a plurality of mounting holes, a plurality of front bolts corresponding to the mounting holes on the rear mounting flange, said right bearing member comprising a hooked portion hooked up with the hooked portion of the corresponding left bearing member, a rail longitudinally disposed at an outer side and fastened to one lip of said outer tire by screw bolts, a friction covering covered over the hooked portion and pressed against the hooked portion of the corresponding right bearing member, a longitudinal row of air holes, and a front plug hole, a rear plug rod corresponding to the front plug hole for mounting, a rear mounting flange, the rear mounting flange of said right bearing member comprising a plurality of mounting holes, and a plurality of front mounting holes corresponding to the mounting holes on the rear mounting flange of said right bearing member for mounting.
